(19) United States
(12) Patent Application Publication
(10) Pub. No.: US 2018/0032246 A1
(43) Pub. Date: Feb. 1, 2018

(54) METHOD AND APPARATUS TO PROVIDE USER INTERFACE

(71) Applicant: Samsung Electronics Co., Ltd., Suwon-si (KR)

(72) Inventor: Junseong KIM, Suwon-si (KR)

(73) Assignee: Samsung Electronics Co., Ltd., Suwon-si (KR)

(21) Appl. No.: 15/584,724

(22) Filed: May 2, 2017

(30) Foreign Application Priority Data
Jul. 29, 2016 (KR) 10-2016-0097275

(51) Int. Cl. G06F 3/0488; G06F 9/44; G06F 3/0484; G06F 3/0481; G06F 3/0482

(52) U.S. Cl. CPC G06F 3/04886; G06F 3/04817; G06F 3/0482; G06F 3/04842; G06F 9/4443; G06F 3/0481

(57) ABSTRACT

A method to provide a user interface (UI) in an electronic device includes: sensing, through a touch screen of the electronic device, a first drag input that drags a target object selected in an interface of a first application; displaying a storage space interface in response to the first drag input, wherein the storage space interface is distinct from the interface of the first application; collecting metadata associated with the target object based on a type of the target object in response to the first drag input being released on the storage space interface; storing the target object and the metadata; and updating the storage space interface based on the target object and the metadata.

### CROSS-REFERENCE TO RELATED APPLICATIONS

This application claims the benefit under 35 USC § 119(a) of Korean Patent Application No. 10-2016-0097275 filed on Jul. 29, 2016, in the Korean Intellectual Property Office, the entire disclosure of which is incorporated herein by reference for all purposes.

### BACKGROUND

### 1. Field

The following description relates to a method and apparatus for providing a user interface (UI).

### 2. Description of Related Art

A UI refers to a physical or virtual medium for interaction between a user and an object or a system, for example, a machine or a computer program. The UI may include a software interface provided through inputs and outputs of a keyboard, a mouse, and a display, and a physical interface such as keyboard arrangement or display shape. That is, the UI may include all elements of physical hardware and logical software.

The performance of the UI may be evaluated based on user experience and usability that allows the user to find a desired element easily and understand an intention of the element. An electronic device including various applications may store data generated while executing an application or transfer the data to another application. UI technology that provides better user experience and usability to a user is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method to provide a user interface (UI) in an electronic device includes: sensing, through a touch screen of the electronic device, a first drag input that drags a target object selected in an interface of a first application; displaying a storage space interface in response to the first drag input, wherein the storage space interface is distinct from the interface of the first application; collecting metadata associated with the target object based on a type of the target object in response to the first drag input being released on the storage space interface; storing the target object and the metadata; and updating the storage space interface based on the target object and the metadata.

The method may further include: displaying a storage space display icon on a side of the touch screen while the first application is being activated, wherein the displaying of the storage space interface in response to the first drag input includes: displaying the storage space interface in response to the first drag input being moved toward the storage space display icon; and displaying a stored object on the storage space interface.

The type may include one or any combination of two or more of a text, an image, music, a video, and multimedia content. The text may include one or both of an email address and an address of a website. The image may include an image of a product.

The updating of the storage space interface may include generating a summary image corresponding to the target object based on the target object and the metadata, and displaying the summary image on the storage space interface. The summary image may include one or any combination of two or more of summary information of the metadata, a heading of the text, a first word of the text, a home page of the website, a thumbnail of the image, and a thumbnail of the video.

The metadata may include a history related to the target object. The history may include one or any combination of two or more of a source, a transmission record, a storage record, and a previous owner of the target object. The source may include the first application. The previous owner may include an entity transmitting the target object through the first application.

The metadata may include one or any combination of two or more of a source application of the target object, a website related to the website, a review of the website, records related to an access to a website to store the target object, an image search result corresponding to the image, a keyword representing the product, a selling price of the product, a review of the product, price comparison information of the product, and a website selling the product.

The method may further include: providing a visual effect of the target object moving as the target object is dragged, in response to the first drag input being sensed; and causing a pop-up displayed in response to the target object being selected in the interface of the first application to disappear.

The updating may include: providing a visual effect of a size of the target object displayed on the storage space interface changing based on a number of objects displayed on the storage space interface.

The method may further include: determining whether the target object selected in the interface of the first application is a storable object; and providing a visual effect of the target object being moved as the target object is dragged, in response to the target object being determined to be a storable object.

The method may further include: copying the first target object onto a clipboard of the electronic device in response to the first target object being stored in a memory of the electronic device, wherein the clipboard is a temporary storage space accessible through an operating system (OS) of the electronic device; deleting the copied first target object from the clipboard in response to the first target object being deleted from the memory; storing a second target object and metadata associated with the second target object in the memory in response to the second target object being copied onto the clipboard; and deleting the stored second target object and the stored metadata associated with the second target object from the memory in response to the second target object being deleted from the clipboard.

The method may further include: sensing, using the touch screen, a second drag input that drags the target object selected in the storage space interface; and pasting the target object into an interface of a second application in response to the second drag input being released on the interface of the second application.

The method may further include: displaying a storage space display icon to activate the storage space interface; and displaying the storage space interface in response to an input with respect to the storage space display icon.

The method may further include: in response to the target object being an address of a website and the second application being a web browser, inputting the address of the website into an address bar of the web browser; and in response to the target object being a text except for the address of the website and the second application being the web browser, inputting the text into a search box of the web browser.

The method may further include: acquiring the stored metadata in response to an input with respect to the target object in the storage space interface; and displaying a pop-up showing the acquired stored metadata.

The method may further include: collecting a history related to the target object in response to the history being generated on the second application; and updating the metadata based on the collected history.

The pasting may include: converting the target object into an object suitable for a target processing protocol of the second application, in response to the target object being excluded from the target processing protocol; and replacing the target object with the object suitable for the target processing protocol and pasting the object suitable for the target processing protocol into the interface of the second application.

A non-transitory computer-readable medium may store program instructions that, when executed by a processor, cause the processor to perform the method.

In another general aspect, an electronic device to provide a user interface (UI) includes: a memory configured to store a target object selected in an interface of a first application, and metadata associated with the target object collected based on a type of the target object; and a processor configured to display a storage space interface distinct from an interface of a second application, sense a drag input that drags the target object using a touch screen, and paste the target object into the interface of the second application in response to the drag input being released on the interface of the second application.

The processor may be further configured to: acquire the stored metadata in response to an input with respect to the target object in the storage space interface; and display a pop-up showing the acquired stored metadata.

The metadata may include a history related to the target object. The processor may be further configured to acquire a transmission record of the target object on the second application, update the metadata stored in the memory based on the acquired transmission record, and update the storage space interface based on the updated metadata.

Other features and aspects will be apparent from the following detailed description, the drawings, and the claims.

### BRIEF DESCRIPTION OF THE DRAWINGS

FIGS. 1A and 1B illustrate a user interface (UI) displayed on a touch screen of an electronic device, according to an embodiment.

FIG. 2 is a block diagram illustrating an electronic device to provide a UI, according to an embodiment.

FIG. 3 is a flowchart illustrating a process to store an object in a method to provide a UI, according to an embodiment.

FIG. 4 is a flowchart illustrating a process to paste an object in a method to provide a UI, according to an embodiment.

FIG. 5 is a block diagram illustrating an electronic device to which a method to provide a UI is applied, according to an embodiment.

FIG. 6 is a flowchart illustrating a method to provide a UI, according to with an embodiment.

FIG. 7 is a flowchart illustrating a method to provide a UI, according to an embodiment.

FIG. 8 is a flowchart illustrating a method to provide a UI, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Specific structural or functional descriptions of examples provided in the present disclosure are exemplary to merely describe the examples. The examples may be modified and implemented in various forms, and the scope of the examples is not limited to the descriptions provided in the present specification.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

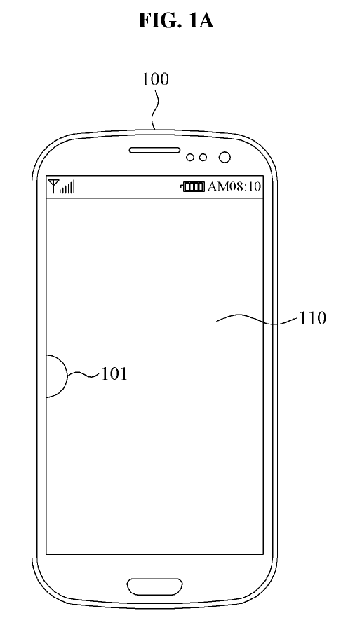

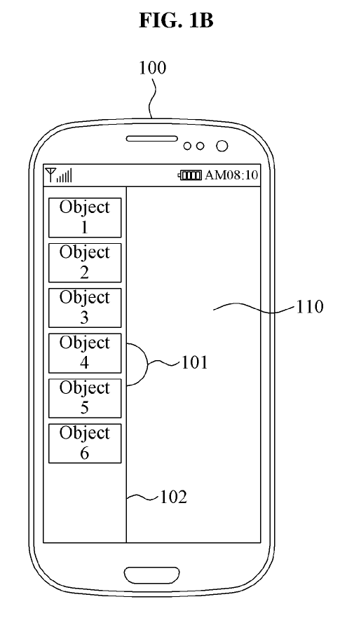

FIGS. 1A and 1B illustrate an example of a user interface (UI) displayed on a touch screen 110 of an electronic device 100, according to an embodiment. Referring to FIGS. 1A and 1B, the electronic device 100 provides the UI and displays the UI on the touch screen 110. The touch screen 110 may include a sensor configured to sense a touch of a user, and the electronic device 100 includes a control system configured to control a software module, a hardware module, or a combination thereof based on a sensed touch. The electronic device 100 may store an application, and may execute the stored application. Alternatively, the electronic device 100 may execute an application without storing the application, by accessing the application through a cloud shared with another device or server. The electronic device 100 is, for example, a smart phone, a tablet personal computer (PC), a personal digital assistant (PDA), a smart car, a smart television (TV), or a computer.

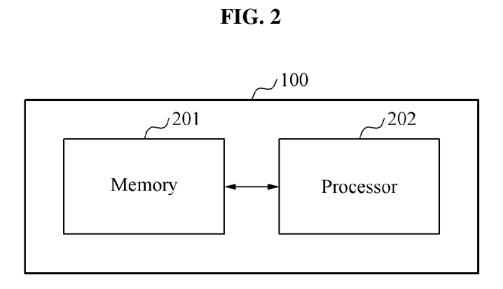

The UI provided by the electronic device 100 helps a user to more easily, intuitively, and conveniently process (for example, store, execute, edit, transmit, and manage) data and an object generated while an application is being executed. The data includes, for example, one or any combination of two or more of a photo, a website, a text, a music file, a document, a video, and multimedia content. The UI provided by the electronic device 100 provides a user experience that transfers an object generated by a predetermined application to the same application or another application. The UI is used to store an object from the predetermined application, and acquire and manage secondary information derived from the stored object, information associated with the stored object, or summary information of the stored object. The UI provided by the electronic device 100 provides a user experience that allows the user to conveniently and intuitively confirm the information associated with the object. Examples of the UI provided by the electronic device 100 will be described in detail with reference to FIGS. 2 through 8.

A method to provide the UI is performed by a UI providing apparatus. The UI providing apparatus may be implemented as one or more software modules, one or more hardware modules, or various combinations of software modules and hardware modules.

In response to an application providing the UI being executed by the electronic device 100, a storage space display icon 101 is displayed on one side of the touch screen 110. The application providing the UI may be implemented as a background application. In response to the application providing the UI being installed on the electronic device 100 in the form of a background application, the application providing a UI operates separately from an application currently being executed without performing a separate starting or setting procedure. In this example, in response to a control instruction related to the application providing the UI being sensed through a touch input of the user on the touch screen 110, an object is copied, stored, transmitted, and managed. More specifically, the method to provide the UI may be implemented as an application independent of one or more other applications executed by the electronic device 100, and thereby may operate at an application level.

In another example, the method to provide the UI is implemented at a system level, and thereby operates through an operating system (OS). In this example, an operating procedure of the method to provide the UI is defined to operate in the OS. An application designed and manufactured based on the OS of the electronic device 100 may copy, store, transmit, and manage an object through the OS in which a protocol for the UI providing method is defined.

Referring to FIGS. 1A and 1B, the UI providing apparatus displays the storage space display icon 101, which is touchable by a user, on the touch screen 110. The UI providing apparatus sets the storage space display icon 101 to be displayed at all times irrespective of a type of an application executed by the electronic device 100. The UI providing apparatus classifies applications based on types of the applications, and displays the storage space display icon 101 in response to an application having a possibility of copying, storing, transmitting, and managing an object being executed in the electronic device 100.

A conventional smart phone displays a pop-up on the touch screen of the smart phone showing functions related to an object to be stored in response to a touch maintained on the touch screen with respect to the object for more than a predetermined time being sensed. The functions shown in the pop-up include, for example, “copy”, “paste”, and “share”. The UI providing apparatus senses a drag input that drags a selected object across the touch screen while maintaining the touch after the touch is sensed.

Referring to FIG. 1B, in response to the drag input being sensed, the UI providing apparatus displays a storage space interface 102 on the touch screen 110. The storage space interface 102 is an interface distinct from an interface of an application providing the selected object. In response to the drag input being sensed, the application providing a UI is activated and the pop-up displayed on the interface of the application providing the selected object visually disappears. Thus, through the drag input that drags the selected object, the user experiences a visual effect of the storage space interface 102 being displayed on a predetermined portion of the touch screen 110 as the pop-up displayed in response to the object being touched disappears.

In response to the drag input being released on the storage space interface 102, the UI providing apparatus stores the object, and updates the storage space interface 102 based on the stored object. The UI providing apparatus may store the object in a memory of the electronic device 100. The UI providing apparatus may also store and manage the object in a cloud that includes a virtual storage space that is accessible by a plurality of servers or devices and allows entities accessing the cloud to share the stored data.

In an embodiment, the UI providing apparatus generates a summary image representing the stored object, and updates the storage space interface 102 by displaying the generated summary image on the storage space interface 102. The storage space interface 102 generates the summary image based on a type of the object. For example, when the object is a photo, the summary image is generated using a thumbnail of the photo. When the object is an address of a website, the summary image may be generated using a home page of the website. When the object is a sentence, the summary image may be generated using a first word of the sentence. The UI providing apparatus may adjust a size of the summary image displayed on the storage space interface 102 based on a size of the object. The UI providing apparatus may also reduce the size of the summary image as a number of stored objects increases. In an example, a minimum size of the summary image is set. In response to a space of the storage space interface 102 being insufficient to display summary images as the number of stored objects increases, the UI providing apparatus updates the storage space interface 102 to display the summary images through dragging or scrolling on the storage space interface 102.

Still referring to FIG. 1B, the UI providing apparatus also senses an input with respect to the storage space display icon 101, and displays the storage space interface 102 in response to the sensed input. The input with respect to the storage space icon 101 is applied and defined in various manners based on sensing of a touch. The UI providing apparatus displays the storage space interface 102 to be distinct from an interface of an application currently being executed by the electronic device 100. The UI providing apparatus visually displays the stored objects on the storage space interface 102.

The UI providing apparatus senses an object being selected on the storage space interface 102, and senses a drag input that drags the selected object. In response to the drag input being released on the interface of the application distinct from the storage space interface 102, the UI providing apparatus pastes the object into the interface on which the drag input is released. In response to the object being successfully pasted, the object may be transmitted from the electronic device 100 to the application providing the interface on which the drag input is released. The object may also be transmitted to the application providing the interface from a cloud accessible by the electronic device 100. The UI providing apparatus thereby provides the user with user experience that allows the user to conveniently input the object stored in the memory or the cloud into an interface of another application.

The UI providing apparatus displays derived information associated with a stored object as a pop-up. In response to an input with respect to the storage space display icon 101 being sensed, the UI providing apparatus visually displays the stored objects on the storage space interface 102. In response to an object displayed on the storage space interface 102 being touched, the UI providing apparatus displays information associated with the touched object as a pop-up. In response to the user maintaining the touch with respect to the touched object for more than a predetermined time, the UI providing apparatus displays a pop-up showing features of one or any combination of two or more of secondary information derived from the touched object, information associated with the touched object, and summary information of the touched object. For example, the information shown in the pop-up is provided in a form of summary of search results related to the touched object and system log information associated with a time at which the touched object was stored. When a photo is stored through an application providing a search by accessing a website, for example, when the object is a photo, log information of the website before the photo is stored, image search results of the photo, and summary information of the search results (for example, product information associated with shoes and a selling price of the shoes when the object is a photo of the shoes) are displayed as a pop-up. When the object is an address of a website, information associated with a website similar to the website and reviews of the website are displayed as a pop-up. Hereinafter, embodiments will be described in detail with reference to FIGS. 2 through 8.

FIG. 2 is a block diagram illustrating an example of an electronic device 100 providing a UI, according to an embodiment. Referring to FIG. 2, the electronic device 100 includes a memory 201 and a processor 202. The electronic device 100 is a touch screen-based electronic device.

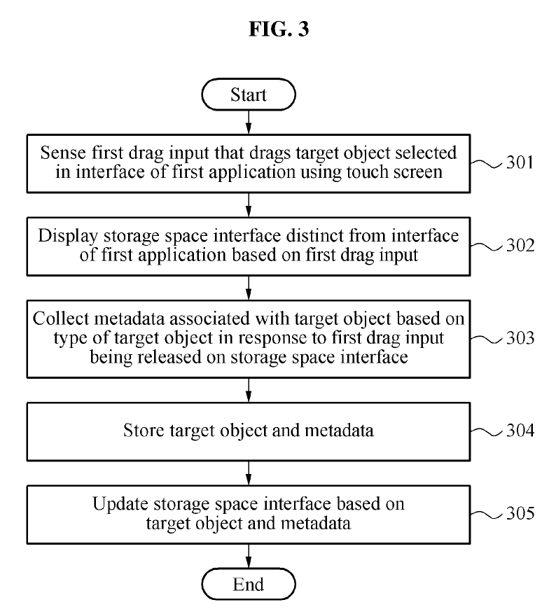

The memory 201 stores a target object selected in an interface of another application distinct from an application generating the target object. The memory 201 stores metadata associated with the target object collected based on a type of target object. The memory 201 may be replaced, for example, with a cloud implemented as a server. A process to store the target object selected through the interface of the other application, and of collecting the metadata will be described with reference to FIG. 3.

Still referencing FIG. 2, the processor 202 provides a UI to store the target object selected in the interface of the other application. For example, the processor 202 stores the target object and the metadata associated with the target object based on a drag input that drags the target object selected in the interface of the other application, and updates the storage space interface 102 (FIG. 1B) based on a storing result. The UI in which the target object is stored will be described with reference to FIG. 3. The UI provided for storing the object is implemented by the processor 202.

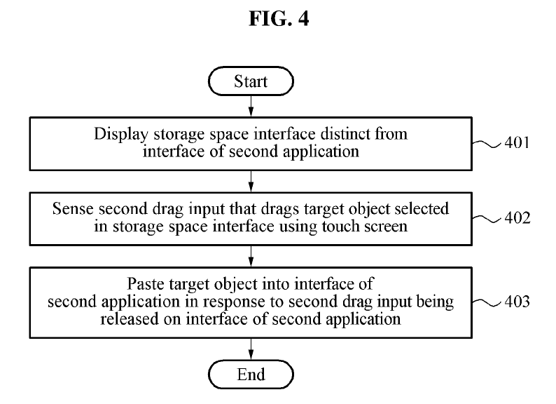

The processor 202 pastes a stored object into the interface of the other application. For example, the processor 202 pastes an object selected in the storage space interface 102 into the interface of the other application based on the drag input that drags the selected object. The UI into which the target object is pasted will be described with reference to FIG. 4. The UI provided for pasting is performed by the processor 202.

FIG. 3 is a flowchart illustrating an example of a process to store an object in a method to provide a UI, according to an embodiment. Referring to FIG. 3, in operation 301, the UI providing apparatus of the electronic device 100 senses a first drag input that drags a target object selected in an interface of a first application using the touch screen 110. For example, the first application is a source application of the target object, and provides an interface distinct from an UI provided. Hereinafter, the first application refers to a source application of an object to be stored, and a second application refers to an application into which the object is to be pasted. The target object refers to an object to be stored, moved, edited, confirmed, pasted, selected, and/or touched through the UI.

The UI providing apparatus displays the storage space display icon 101 on one side of the touch screen 110 while the first application is being activated. When the UI providing method is implemented as a background application independent of the first application, the storage space display icon 101 is displayed on one side of the touch screen 110 at all times irrespective of whether the first application is activated. Further, when the UI providing method is defined through an OS, the storage space display icon 101 is displayed on one side of the touch screen 110 at all times at a system level, irrespective of whether the first application is activated.

Selection of the target object performed on the interface of the first application is processed using a scheme defined by the first application or the OS of the electronic device 100. For example, in response to a touch with respect to a predetermined object being maintained on the interface of the first application for more than a predetermined time, the OS or the first application provides an interface to select the predetermined object. The selected object is a target object.

The UI providing apparatus determines whether the target object selected in the interface of the first application is a storable object. When the target object is determined to be a storable object, the UI providing apparatus provides a visual effect of the target object moving as the target object is dragged. For example, when the first application is an application to execute a web page and a blank screen not including a text or an image is selected on the web page, the UI providing apparatus determines that the selected object does not correspond to a storable object. In this example, the UI providing apparatus does not respond to the drag input. For example, the visual effect of the object moving as the target object is dragged is not provided or the storage space interface 102 is not displayed.

In operation 302, the UI providing apparatus displays the storage space interface 102, which is distinct from the interface of the first application, based on the first drag input. More specifically, in response to the first drag input being sensed, the UI providing apparatus determines whether the sensed first drag input is moved toward the storage space display icon 101 and displays the storage space interface 102 based on the first drag input being moved toward the storage space display icon 101. In response to the first drag input being sensed, the UI providing apparatus provides a visual effect of the target object moving as the target object is dragged. In response to the first drag input being sensed on the storage space display icon 101, the UI providing apparatus displays the storage space interface 102. A scheme of generating an instruction to trigger displaying of the storage space interface 102 is defined in various manners based on a touch motion with respect to the target object.

When the method to provide the UI is implemented as an application independent of the first application, the application performing the method is activated in response to the first drag input. In this example, in response to the application independent of the first application being activated, a visual effect of a pop-up displayed through the interface of the first application disappearing is provided to a user. When the method to provide the UI is implemented through an OS at a system level, the OS performing the method is activated in response to the first drag input. In this example, the visual effect of the pop-up displayed through the interface of the first application disappearing is provided to the user based on the first drag input.

The UI providing apparatus displays a stored object on the storage space interface 102. For example, the UI providing apparatus visually displays an object stored in the memory 201 or cloud on the storage space interface 102. A scheme of visualizing the object on the storage pace interface 102 is implemented so as to be variable as defined by the user.

In operation 303, the UI providing apparatus collects metadata associated with the target object based on a type of the target object in response to the first drag input being released on the storage space interface 102. The metadata is data associated with the target object collected through the UI providing method, and includes one or any combination of two or more of secondary information derived from the target object, information associated with the target object, and summary information of the target object.

The type of the target object includes one or any combination of two or more of a text, an image, music, a video, and multimedia content. The text may include one or both of an email address and an address of a website. The image may include an image of a product. The metadata associated with the target object may include a history related to the target object. The history may include one or any combination of two or more of a source, a transmission record, a storage record, and a previous owner of the target object. The source includes the first application, and the previous owner of the target object includes an entity transmitting the target object through the first application.

Further, the metadata includes one or any combination of two or more of a source application of the target object, a website related to the website, a review of the website, records related to an access to a website to store the target object, an image search result corresponding to the image, a keyword representing the product, a selling price of the product, a review of the product, price comparison information of the product, and a website selling the product. When storing the target object, the UI providing apparatus collects, based on the type of the target object, the information associated with the target object through a search of the website or through system log information of a source application of the target object, collects identification information classified by the type of the target object, collects an image search result through an image search of the target object, or collects metadata by combining texts related to the target object and extracting a keyword. A path or scheme of collecting metadata in the method to provide the UI is not limited to the paths or schemes described above, and various paths or schemes may be adopted and applied.

In operation 304, the UI providing apparatus stores the target object and the metadata. The UI providing apparatus stores mapping information to match the target object and the metadata. The target object and the metadata may be stored permanently in the memory 201 in a form of files through the OS or the application performing the method. The electronic device 100 records objects copied in a copy and paste operation in a temporary storage space. Thus, when the electronic device 100 is turned off, the objects recorded in the temporary storage space may be deleted. However, in an example of the UI providing method, by assigning a separate memory space to store the target object and the metadata, the target object and the metadata may be accessed and managed in the form of files.

In response to the target object being stored in the memory 201 of the electronic device, the UI providing apparatus copies the target object onto a clipboard that is a temporary storage space accessible through the OS of the electronic device. In response to the target object being deleted from the memory 201, the UI providing apparatus deletes the copied target object from the clipboard. The UI providing apparatus interoperates with the clipboard provided through the OS, thereby storing the target object in the memory 201 or deleting the target object from the memory 201, and, at the same time, storing the target object in the clipboard or deleting the target object from the clipboard.

In response to the target object being copied onto the clipboard, the UI providing apparatus stores the target object and the metadata associated with the target object in the memory. When copying of the target object through the clipboard is recognized, the UI providing apparatus collects the metadata associated with the target object and stores the target object and the metadata in the memory 201 by matching the target object and the metadata. In response to the target object being deleted from the clipboard, the UI providing apparatus deletes the target object and the metadata associated with the target object stored in the memory 201. The UI providing apparatus interoperates with the clipboard provided through the OS, thereby recognizing an operation of copying the target object onto the clipboard or deleting the target object from the clipboard, and, at the same time, performing an operation of storing the target object in the memory 201 or deleting the target object from the memory 201 at the same time.

In operation 305, the UI providing apparatus updates the storage space interface 102 based on the target object and the metadata. For example, the UI providing apparatus generates a summary image corresponding to the target object based on the target object and the metadata, and displays the summary image on the storage space interface 102. The summary image includes summarized information representing the target object and the metadata, and is implemented as one or any combination of two or more of a text, a photo, a video, or multimedia content. For example, the summary image includes one or any combination of two or more of summary information of the metadata, a heading of the text, a first word of the text, a home page of a website, a thumbnail of the image, and a thumbnail of the video.

The UI providing apparatus may provide a visual effect of a size of the target object displayed on the storage space interface 102 changing based on a number of objects displayed on the storage space interface 102. The UI providing apparatus may display objects on the storage space interface 102 to be visualized differently based on file sizes of the objects.

In response to an input with respect to the target object being sensed in the storage space interface 102, the UI providing apparatus acquires the stored metadata. The metadata is stored and mapped with the target object. The UI providing apparatus displays a pop-up showing the acquired metadata. The user confirms the objects displayed on the storage space interface 102 by touching the storage space display icon 101. The UI providing apparatus stores metadata collected based on types of the objects, and visually displays the metadata. Thus, the user may intuitively confirm information associated with the stored object or information provided based on a type of the object. For example, an image of a product of a predetermined website is stored based on the UI providing method. The UI providing apparatus provides user experience that allows the user to intuitively confirm one or any combination of two or more of an access history of the website, a similar website selling the product, a review of the product, a recommended product suggested in relation to the product, price comparison information of the product, analysis data of age and gender preferring the product, and changes in sales of the product, through the information associated with the image of the product displayed on the storage space interface 102.

FIG. 4 is a flowchart illustrating a process to paste an object in a method to provide a UI, according to an embodiment. Referring to FIG. 4, in operation 401, a UI providing apparatus displays the storage space interface 102, which is distinct from an interface of a second application. The UI providing apparatus displays a storage space display icon 101 to activate the storage space interface 102, and displays the storage space interface 102 based on an input with respect to the storage space display icon 101. The features and operations described with reference to FIGS. 1A through 3 apply to an example of displaying the storage space display icon 101 and the storage space interface 102.

In operation 402, the UI providing apparatus senses a second drag input that drags a target object selected in the storage space interface 102 using the touch screen 110. A user input that selects the target object in the storage space interface 102 may be defined using various touch screen-based methods. For example, the UI providing apparatus recognizes that the target object is selected in response to a touch with respect to the target object on the storage space interface 102 being sensed.

In operation 403, the UI providing apparatus pastes the target object into the interface of the second application in response to the second drag input being released on the interface of the second application. When the UI providing method is implemented by a protocol defined by an OS at a system level, the second application supports a pasting operation based on the UI providing method. Thus, the second application inputs the target object through the interface of the second application. When the UI providing method is implemented as an application independent of the second application, the UI providing apparatus pastes the target object through the protocol shared with the second application. In this example, the second application inputs the target object based on a protocol defined in advance through the interface of the second application.

When the target object is not included in a target processing protocol of the second application, the UI providing apparatus converts the target object into an object suitable for the target processing protocol supported by the second application. The UI providing apparatus replaces the target object with the suitable object, and pastes the suitable object into the interface of the second application.

In an example, when the target object is an address of a website and the second application is a web browser, an interface to input the address of the website into an address bar of the web browser is provided. When the target object is a text other than the address of the website and the second application is the web browser, an interface to input the text into a search box of the web browser is provided.

The UI providing apparatus collects a history related to the target object in response to the history being generated on the second application. The UI providing apparatus updates metadata based on the collected history, and stores the updated metadata in the memory 201. For example, the UI providing apparatus acquires a transmission record of the target object on the second application, and updates the metadata stored in the memory 201 based on the acquired transmission record. The UI providing apparatus updates the storage space interface 102 based on the updated metadata.

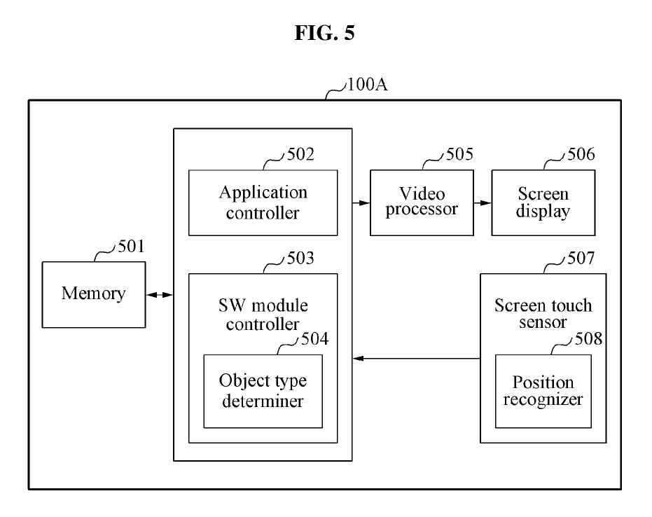

FIG. 5 is a block diagram illustrating an electronic device 100A to which a method to provide a UI is applied, according to an embodiment. Referring to FIG. 5, the electronic device 100A includes a memory 501, an application controller 502, a software (SW) module controller 503, an object type determiner 504, a video processor 505, a screen display 506, a screen touch sensor 507, and a position recognizer 508. In response to a user touching a storage space display icon 101 displayed on the touch screen 110, the screen touch sensor 507 senses the touch with respect to the touch screen 110, and the position recognizer 508 recognizes a position of the storage space display icon 101 and transfers a recognition result to the SW module controller 503. The SW module controller 503 generates a control instruction by recognizing the touch with respect to the storage space display icon 101. The SW module controller 503 transfers the generated control instruction to the video processor 505. The video processor 505 generates a screen processing instruction by processing the received control instruction, and transfers the generated screen processing instruction to the screen display 506. The screen display 506 visually displays the storage space interface 102 on the touch screen 110 based on the received screen processing instruction.

In response to the user dragging an object and releasing the drag input on the storage space interface 102 to store the object, the screen touch sensor 507 senses a touch related to the drag input, and the position recognizer 508 recognizes a position of the touch and transfers a recognition result to the SW module controller 503. The SW module controller 503 generates a control instruction by recognizing the drag input with respect to the object and the drag input being released on the storage space interface 102. The SW module controller 503 collects metadata associated with the object based on the generated control instruction, and stores the collected metadata and the object in the memory 501. The SW module controller 503 transfers the control instruction related to storing the object to the video processor 505. The video processor 505 generates a screen processing instruction by processing the received control instruction, and transfers the generated screen processing instruction to the screen display 506. The screen display 506 visually displays the stored object on the storage space interface 102 based on the received screen processing instruction. The object type determiner 504 determines a type of the object, and the SW module controller 503 collects metadata based on the determined type of the object. The SW module controller 503 processes a search for a website related to the object and a search for source application information based on the type of the object, and stores the metadata in the memory 501.

In response to the user dragging an object displayed on the storage space interface 102 and releasing the drag input on an interface of another application to paste the object, the screen touch sensor 507 senses a touch related to the drag input, and the position recognizer 508 recognizes a position of the touch and transfers a recognition result to the SW module controller 503. The SW module controller 503 generates a control instruction by recognizing the drag input with respect to the object and the drag input being released on the interface of the other application. The SW module controller 503 acquires the object from the memory 501 based on the generated control instruction, and generates an instruction to paste the object into the interface of the other application. The SW module controller 503 transfers the control instruction related to pasting of the object to the video processor 505. The video processor 505 generates a screen processing instruction by processing the received control instruction, and transfers the generated screen processing instruction to the screen display 506. The screen display 506 provides a visual effect of the object moving based on the drag input through a display based on the received screen processing instruction. In response to the drag input with respect to the object being released on the interface of the other application, the application controller 502 acquires the object from the memory 501. The application controller 502 controls the application providing the interface in which the drag input is released.

In response to the user touching an object displayed on the storage space interface 102 for more than a predetermined time to confirm information associated with the stored object, the screen touch sensor 507 senses the touch, and the position recognizer 508 recognizes a position of the touch and transfers a recognition result to the SW module controller 503. The SW module controller 503 generates a control instruction by recognizing that the touch with respect to the object is maintained for more than the predetermined time. The SW module controller 503 acquires metadata corresponding to the object from the memory 501 based on the generated control instruction, and generates a control instruction related to a pop-up showing the metadata. The SW module controller 503 transfers the control instruction related to the pop-up to the video processor 505. The video processor 505 generates a screen processing instruction by processing the received control instruction, and transfers the generated screen processing instruction to the screen display 506. The screen display 506 displays the pop-up showing the metadata on the touch screen 110 based on the received screen processing instruction.

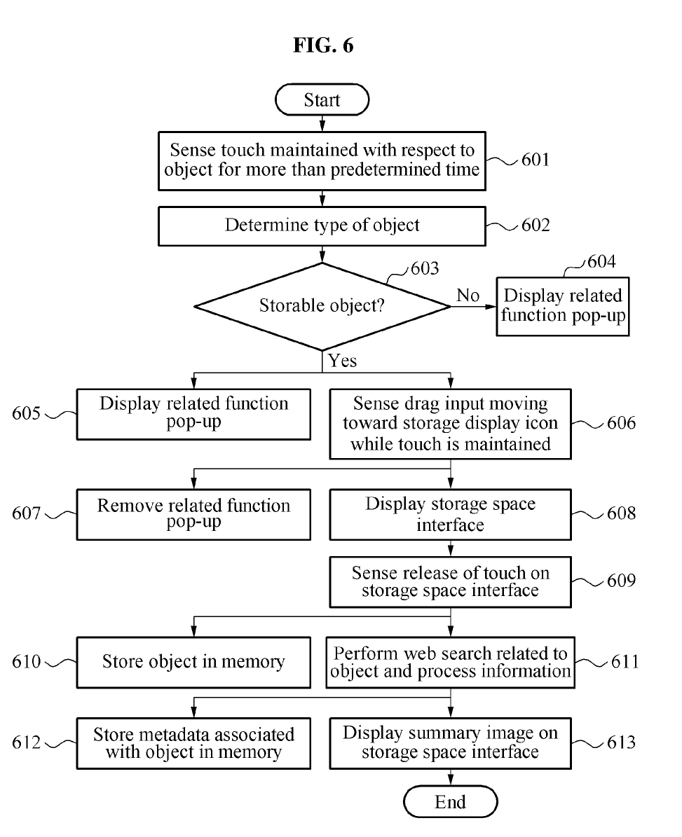

FIG. 6 is a flowchart illustrating a method to provide a UI, according to an embodiment. Referring to FIG. 6, in response to a user touching an object to be stored for more than a predetermined time, a UI providing apparatus senses the touch in operation 601, and determines a type of the object in operation 602. In operation 603, the UI providing apparatus determines whether the object is a storable object based on the determined type. In operations 604 and 605, the UI providing apparatus displays a related function pop-up provided in response to the object being touched for more than the predetermined time on an interface of an application. In response to determination that the object is storable, the UI providing apparatus senses a drag input with respect to the object. In operation 606, the UI providing apparatus senses the drag input moved toward the storage space display icon 101 while the touch with respect to the object is maintained. In operation 608, the UI providing apparatus displays the storage space interface 102 in response to the drag input being sensed. In operation 607, the UI providing apparatus removes the pop-up displayed by the interface of the application in response to the drag input. In operation 609, the UI providing apparatus determines whether the touch is released on the storage space interface 102. For example, the UI providing apparatus senses a release of the drag input with respect to the object. In operation 610, the UI providing apparatus stores the object in the memory 201/501 in response to the drag input being released. In operation 611, the UI providing apparatus performs a web search and processes information associated with the object. In operation 612, the UI providing apparatus stores metadata related to the object, generated as a result of operation 611, in the memory 201/501. In operation 613, the UI providing apparatus displays a summary image on the storage space interface 102 based on the object and the metadata stored in the memory.

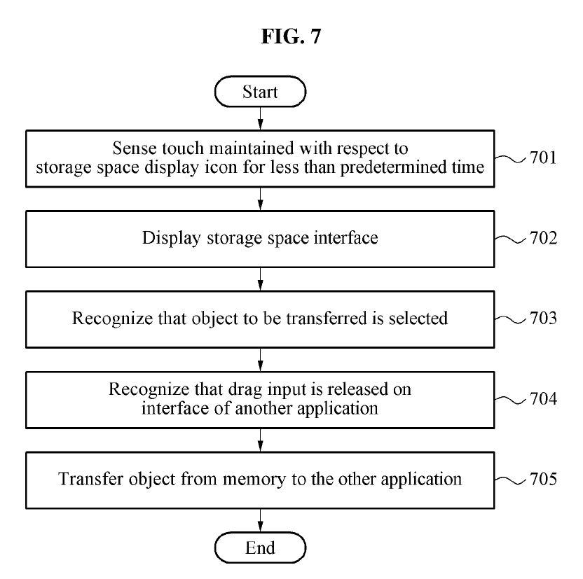

FIG. 7 is a flowchart illustrating a method to provide a UI, according to an embodiment. Referring to FIG. 7, in response to a user touching the storage space display icon 101 for less than a predetermined time, the UI providing apparatus senses the touch in operation 701, and displays the storage space interface 102 in operation 702. In response to the user touching an object to be transferred on the touch screen 110, the UI providing apparatus recognizes that the object to be transferred is selected in operation 703. In response to the user dragging the object within a predetermined time and releasing the touch on an interface of another application, the UI providing apparatus recognizes that the drag input with respect to the object is released on the interface of the other application in operation 704. In operation 705, the UI providing apparatus acquires the object from the memory 201/501, and pastes the acquired object into the interface of the other application, thereby transferring the object to the other application.

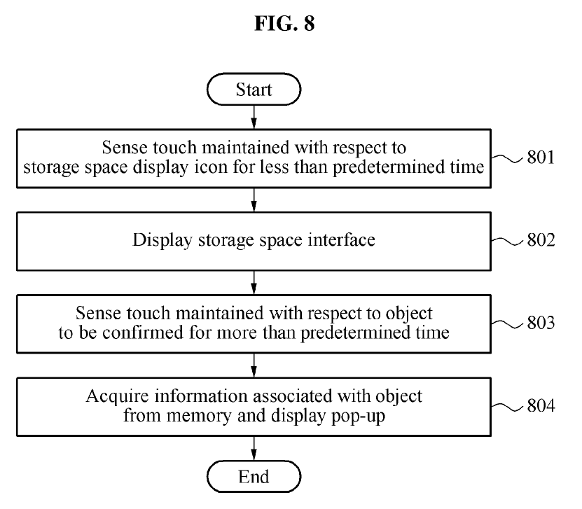

FIG. 8 is a flowchart illustrating a method to provide a UI, according to with an embodiment.

Referring to FIG. 8, in response to a user touching the storage space display icon 101 for less than a predetermined time, the UI providing apparatus senses the touch in operation 801, and displays the storage space interface 102 in operation 802. In response to the user touching a position of an object to be confirmed for more than a predetermined time on the touch screen 110, the UI providing apparatus recognizes an input related to a pop-up of the object in operation 803. In operation 804, the UI providing apparatus acquires information, for example, metadata, related to the object from the memory 201/501, and displays the pop-up based on the acquired information.

The memory 201 and the processor 202 in FIG. 2, and the memory 501, the application controller 502, the SW module controller 503, the object type determiner 504, the video processor 505, the screen display 506, the screen touch sensor 507 and the position recognizer 508 in FIG. 5 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3, 4 and 6-8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

As a non-exhaustive example only, a terminal or device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method to provide a user interface (UI) in an electronic device, the method comprising:
sensing, through a touch screen of the electronic device, a first drag input that drags a target object selected in an interface of a first application;
displaying a storage space interface in response to the first drag input, wherein the storage space interface is distinct from the interface of the first application;
collecting metadata associated with the target object based on a type of the target object in response to the first drag input being released on the storage space interface;
storing the target object and the metadata; and
updating the storage space interface based on the target object and the metadata.

2. The method of claim 1, further comprising:
displaying a storage space display icon on a side of the touch screen while the first application is being activated,
wherein the displaying of the storage space interface in response to the first drag input comprises:
displaying the storage space interface in response to the first drag input being moved toward the storage space display icon; and
displaying a stored object on the storage space interface.

3. The method of claim 1, wherein:
the type comprises one or any combination of two or more of a text, an image, music, a video, and multimedia content;
the text comprises one or both of an email address and an address of a website; and
the image comprises an image of a product.

4. The method of claim 3, wherein:
the updating of the storage space interface comprises
generating a summary image corresponding to the target object based on the target object and the metadata, and
displaying the summary image on the storage space interface; and
the summary image comprises one or any combination of two or more of summary information of the metadata, a heading of the text, a first word of the text, a home page of the website, a thumbnail of the image, and a thumbnail of the video.

5. The method of claim 3, wherein:
the metadata comprises a history related to the target object;
the history comprises one or any combination of two or more of a source, a transmission record, a storage record, and a previous owner of the target object;
the source comprises the first application; and
the previous owner comprises an entity transmitting the target object through the first application.

6. The method of claim 3, wherein the metadata comprises one or any combination of two or more of a source application of the target object, a website related to the website, a review of the website, records related to an access to a website to store the target object, an image search result corresponding to the image, a keyword representing the product, a selling price of the product, a review of the product, price comparison information of the product, and a website selling the product.

7. The method of claim 1, further comprising:
providing a visual effect of the target object moving as the target object is dragged, in response to the first drag input being sensed; and
causing a pop-up displayed in response to the target object being selected in the interface of the first application to disappear.

8. The method of claim 1, wherein the updating comprises:
providing a visual effect of a size of the target object displayed on the storage space interface changing based on a number of objects displayed on the storage space interface.

9. The method of claim 1, further comprising:
determining whether the target object selected in the interface of the first application is a storable object; and
providing a visual effect of the target object being moved as the target object is dragged, in response to the target object being determined to be a storable object.

10. The method of claim 1, further comprising:
copying the first target object onto a clipboard of the electronic device in response to the first target object being stored in a memory of the electronic device, wherein the clipboard is a temporary storage space accessible through an operating system (OS) of the electronic device;
deleting the copied first target object from the clipboard in response to the first target object being deleted from the memory;
storing a second target object and metadata associated with the second target object in the memory in response to the second target object being copied onto the clipboard; and
deleting the stored second target object and the stored metadata associated with the second target object from the memory in response to the second target object being deleted from the clipboard.

11. The method of claim 1, further comprising:
sensing, using the touch screen, a second drag input that drags the target object selected in the storage space interface; and
pasting the target object into an interface of a second application in response to the second drag input being released on the interface of the second application.

12. The method of claim 11, further comprising:
displaying a storage space display icon to activate the storage space interface; and
displaying the storage space interface in response to an input with respect to the storage space display icon.

13. The method of claim 11, further comprising:
in response to the target object being an address of a website and the second application being a web browser, inputting the address of the website into an address bar of the web browser; and
in response to the target object being a text except for the address of the website and the second application being the web browser, inputting the text into a search box of the web browser.

14. The method of claim 11, further comprising:
acquiring the stored metadata in response to an input with respect to the target object in the storage space interface; and
displaying a pop-up showing the acquired stored metadata.

15. The method of claim 11, further comprising:
collecting a history related to the target object in response to the history being generated on the second application; and
updating the metadata based on the collected history.

16. The method of claim 11, wherein the pasting comprises:
converting the target object into an object suitable for a target processing protocol of the second application, in response to the target object being excluded from the target processing protocol; and
replacing the target object with the object suitable for the target processing protocol and pasting the object suitable for the target processing protocol into the interface of the second application.

17. A non-transitory computer-readable medium storing program instructions that, when executed by a processor, cause the processor to perform the method of claim 1.

18. An electronic device to provide a user interface (UI), the electronic device comprising:
a memory configured to store a target object selected in an interface of a first application, and metadata associated with the target object collected based on a type of the target object; and
a processor configured to
display a storage space interface distinct from an interface of a second application,
sense a drag input that drags the target object using a touch screen, and
paste the target object into the interface of the second application in response to the drag input being released on the interface of the second application.

19. The electronic device of claim 18, wherein the processor is further configured to:
acquire the stored metadata in response to an input with respect to the target object in the storage space interface; and
display a pop-up showing the acquired stored metadata.

20. The electronic device of claim 18, wherein:
the metadata comprises a history related to the target object; and
the processor is further configured to
acquire a transmission record of the target object on the second application,
update the metadata stored in the memory based on the acquired transmission record, and
update the storage space interface based on the updated metadata.
